(19) United States
(12) Patent Application Publication
(10) Pub. No.: US 2005/0154807 A1
(43) Pub. Date: Jul. 14, 2005

(54) Converting module for connecting a memory card to a projector

(76) Inventor: Tsung Lung Chao, Hsinchu (TW)

Correspondence Address: BIRCH STEWART KOLASCH & BIRCH, PO BOX 747, FALLS CHURCH, VA, 22040-0747, US

(21) Appl. No.: 10/756,461

(22) Filed: Jan. 14, 2004

(51) Int. Cl. G06F 13/12

(52) U.S. Cl. 710/62

(57) ABSTRACT

A converting module for connecting a memory card to a projector is provided. The converting module is modulized and coupled to the projector so that the projector can directly read and play the image data stored in the memory card on the basis of not altering the system configuration of the projector itself. Furthermore, I2C communication protocol is used as the standard of signal transmission between the memory card and the projector so as to save cost of designing pertinent hardware and software.

### BACKGROUND OF THE INVENTION

1. Field of the Invention

The invention generally relates to a converting module, and in particular relates to a converting module for connecting a memory card to a projector.

2. Related Art

As digital cameras being widely used, people are gradually accustomed to use digital cameras for recording images. Digital cameras take pictures; transfer them into digital signals and store into flash memory cards mounted on the cameras. The memory card stores a lot of images, more than a conventional film can do. When users want to view the images, they only need to transfer the image data from the memory card to a display device, without the need of the developing and printing processes for a conventional film.

However, the transmission interface between the memory card and the display device requires specific software and hardware that increase the complicacy and inconvenience of the application. Especially, when a user want to show the images in the memory card through a projector, the user has to connect the memory card to a computer having a memory card transmission interface for reading the image data into the computer and transferring the image data to the projector for display. The process is rather complicated and inconvenient.

Therefore, it is desired to a module applicable to a projector for reading image data from the memory card directly so as to simplify the process without changing the original configuration of the projector.

### SUMMARY OF THE INVENTION

The object of the invention is to provide a converting module for connecting a memory card to a projector so that the projector can display the image data stored in the memory card.

A converting module according to the invention includes an interface processing unit, a register, a microprocessor and a memory unit. Through the interface processing unit, a universal serial bus (USB) connects to the memory card for transferring the image data stored in the memory card in a serial format to the interface processing unit. The interface processing unit further transfers the serial data to the register and stores there.

Then, the microprocessor receives commands from the projector that define resolution, updating rate, etc. of the image data so as to read the related program stored in the memory unit according to the commands. After processing the image data stored in the register, the image signals are transferred to the projector for display.

The signal transmission between the projector and the microprocessor is via I2C bus. The I2C bus is composed of a serial clock (SCL) bus and a serial data (SDA) bus that the SCL bus transfers time signals for controlling the data transmission, and the SDA bus transfers the data and commands.

### BRIEF DESCRIPTION OF THE DRAWINGS

The invention will become more fully understood from the detailed description given hereinbelow. However, this description is for purposes of illustration only, and thus is not limitative of the invention, wherein:

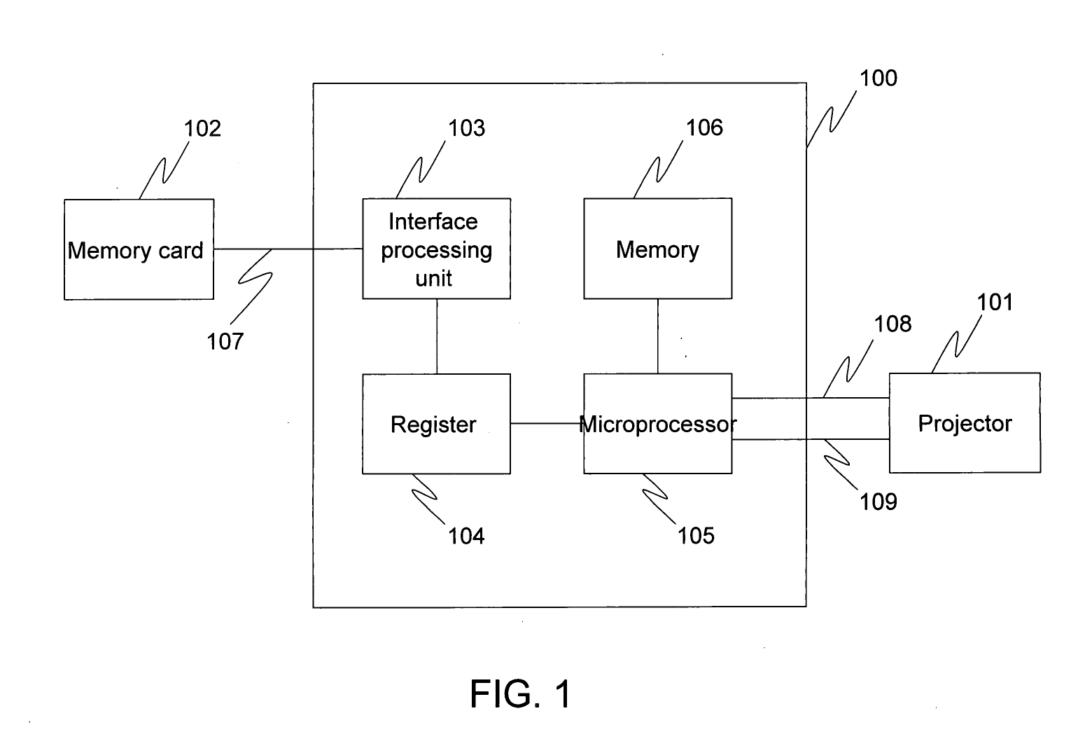

The sole FIG. 1 is a circuit block diagram of the invention.

### DETAILED DESCRIPTION OF THE INVENTION

As shown in FIG. 1, a circuit block diagram of the invention, the converting module 100 is mounted on, or placed individually from, a projector 101 through connections of an interface. The converting module 100 connects with a memory card 102 so that the projector 101 can read the image data stored in the memory card 102 and display.

The memory card 102 can be plugged to a digital camera (not shown) for storing the image data it takes, The memory card 102 can be a CompactFlash card, MicroDrive card, SmartMedia card, memory stick, Secure Digital (SD) card or MultiMedia card (MMC) and so on.

The converting module 100 includes an interface processing unit 103, a register 104, a microprocessor 105 and a memory unit 106. The interface processing unit 103 connects to the memory card 102 for reading and transferring the image data to the register 104. The interface processing unit 103 utilizes a universal serial bus (USB) 107 to transfer image data in a serial data format from the memory card 102 to the interface processing unit 103. After converting the serial data into parallel data, the interface processing unit 103 stores the data in the register 104.

The register 104 connects to the interface processing unit 103 for storing the image data read from the memory card 102 and processed by the microprocessor 103.

The microprocessor 105 connects to the register 104 for processing and converting image data. The microprocessor 15 can be a 8051 or 8086 single chip CPU. The microprocessor 105 reads data from the register 104 and processes for output.

The memory unit 106 connects to the microprocessor 105 for storing software of the microprocessor 105 that handles the image conversion and processing.

The projector 101 connects to the microprocessor 105 of the converting module 100 for data transmission through an I2C bus. The projector 101 also outputs commands to the microprocessor 105 for informing the microprocessor 105 to read relative software from the memory unit 106, to process accordingly and to output the image data to the projector 101 for display.

The commands of the projector 101 define the image resolution, data updating rate and methods of playing, such as playing forwards, backwards, repeatedly, etc..

The I2C bus includes a serial clock bus 108 and a serial data bus 109. The serial clock bus 108 transfers time signals for controlling the data transmission. The serial data bus 109 transfers data and commands. 5 After the converting module 100 of the invention being connected to a projector 101, the microprocessor 105 of the converting module 100 connects to the projector; the memory card 102 connects to the interface processing unit 103; then, the projector 101 commands the microprocessor 105 to read image data from the memory card 102, and defines the resolution, the updating rate and the playing method of the image.

The microprocessor 105 receives the commands of the projector 101, then starts to read the image data from the memory card 102 via the interface processing unit 103. The interface processing unit 103 receives the serial data, transforms them into parallel data to be stored in the register 104. Then, the microprocessor 105 reads relative software from the memory unit 106 and reads the image data stored in the register 104. The microprocessor 105 processes the data with the relative software and outputs to the projector 101 for display.

The data and command transmission procedure between the projector 101 and the microprocessor 105 is that when the projector 101 and the microprocessor 105 are idle, the serial clock bus 108 and the serial data bus 109 are in high potential. Before the projector 101 sending commands to the microprocessor 105, the serial data bus 109 first changes to low potential. After a short time, the serial clock bus 108 changes to low potential. Then, the projector 101 sends a start signal to the microprocessor 105, and further sends its address signal to the microprocessor 105 to trigger the conversation.

When the microprocessor 105 correctly receives the start and address signals from the projector 101, it returns an acknowledge signal to the projector 101. The projector 101 keeps the serial data bus 109 at high potential. The microprocessor 105 changes the serial data bus 109 to low potential for confirmation. If the microprocessor 105 cannot correctly receive the signal of the projector 101, it holds and keeps the serial data bus 109 at high potential.

The projector 101 starts sending commands after the microprocessor 105 confirms. The commands define the information of image playing, including the resolution, the updating rate and so on.

When the data transmission from the projector 101 to the microprocessor 105 is finished, the serial clock bus 108 is first released to high potential. After a short time, the serial data bus 109 is also released to high potential so as to end the data transmission.

The converting module 100 of the invention is not only applicable to a projector 101 but also applicable to other kinds of display, such as LCD, plasma display and CRT.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A converting module, connecting to a projector and a memory card, for reading image data from said memory card and playing said image with said projector, comprising:
an interface processing unit, connecting to said memory card, for reading image data stored in said memory card;
a register, connecting to said interface processing unit, for storing said image data read by said interface processing unit;
a microprocessor, connecting to said register and said projector, for receiving commands from said projector, processing said image data stored in said register, and outputting said image data to said projector to display; and
a memory unit, connecting to said microprocessor, for storing at least software for said microprocessor to apply in processing and transmission of said image data.

2. A converting module according to claim 1 wherein said interface processing unit connects to said memory card via a universal serial bus; said image data stored in said memory card is transferred to said interface processing unit in a serial format, and converted into parallel data by said interface processing unit when being outputted to said register.

3. A converting module according to claim 1 wherein said microprocessor is a 8051 single chip.

4. A converting module according to claim 1 wherein said microprocessor is a 8086 single chip.

5. A converting module according to claim 1 wherein said microprocessor connects to said projector via a I2C bus.

6. A converting module according to claim 1 wherein said commands from said projector define at least resolution of said image display.

7. A converting module according to claim 1 wherein said commands from said projector define at least updating rate of said image display.

8. A converting module according to claim 1 wherein said commands from said projector define at least display method of said image.
